(19) United States
(12) Patent Application Publication
(10) Pub. No.: US 2010/0187764 A1
(43) Pub. Date: Jul. 29, 2010

(54) SEAL CAVITY PROTECTION

(76) Inventor: Alan James Roddis, Sheffield (GB)

Correspondence Address: EDWIN D. SCHINDLER, FIVE HIRSCH AVENUE, P.O. BOX 966, CORAM, NY, 11727-0966, US

(21) Appl. No.: 12/669,564

(22) PCT Filed: Jul. 18, 2008
(86) PCT No.: PCT/GB2008/002483

§ 371 Date: Jan. 28, 2010

(30) Foreign Application Priority Data
Jul. 19, 2007 (GB) 0714101.3

(51) Int. Cl. F16J 15/16

(52) U.S. Cl. 277/351

(57) ABSTRACT

A seal cavity throat bushing, for use with rotating fluid equipment having a seal cavity, is defined by a rotary shaft having an axis. The shaft housing surrounds at least a portion of the shaft and a sealing device engages the shaft and the housing at one end of the cavity. The bushing includes an annular element, which is adapted for a tight fit in a housing at the entrance to the cavity opposite the one end. The annular element has a radially outer cylindrical surface for contacting a cavity wall of the housing and a radially cylindrical surface having a diameter greater than that of the shaft to define a gap there-between.

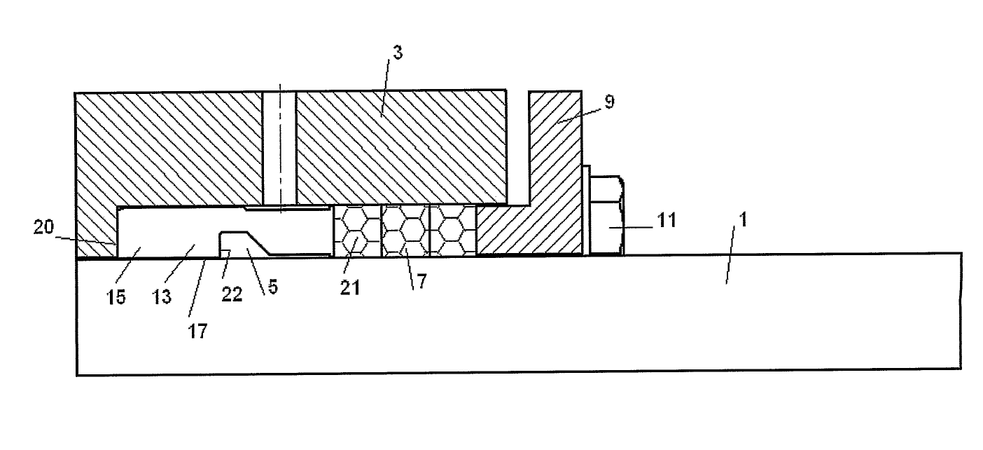

### FIELD OF THE INVENTION

This invention is concerned with devices, known as throat bushings, which can be positioned at the entrance to a seal cavity in rotating fluid equipment to protect the cavity and any seal contained in the cavity from contaminants, particulate material and/or to increase the fluid pressure within the cavity.

### BACKGROUND TO THE INVENTION

Pumps are used in industry for a variety of different purposes. It is not uncommon for pumps to fail, particularly in heavy industries, because of contaminants contained within the pump system or within the pump itself. Pumps are provided with various types of seals, bushings and packing arrangements to protect the components of the pumps from contamination and subsequent wear or damage.

The use of a so-called throat bushing has been proposed. The SpiralTrac seal protector, manufactured by EnviroSeal Engineering Products Ltd of Nova Scotia, Canada, is an annular bushing which is placed at the entrance to a seal cavity of a pump, the cavity being defined by a portion of the pump housing, a shaft that extends through the cavity, and means for sealing the cavity itself. The sealing means may take the form of a mechanical seal positioned at one (the distal) end of the cavity or it may be packing material that fills the cavity. In either case, the SpiralTrac bushing is positioned at the proximal end of the cavity. The bushing includes a tapered central surface which has a spiral groove formed in its wall and which extends from adjacent the outer surface of the bushing towards the cavity entrance. The spiral groove decreases in diameter down to the innermost diameter of the bushing, which defines a small angular gap around the shaft.

As the shaft rotates any particulate material that enters the seal cavity during operation of the pump will is centrifugally forced into the spiral groove and flows therealong towards the gap around the shaft. The particulate material is forced outwardly through the gap to the exterior of the seal cavity.

Disadvantages of the above described throat bushing are that the use of a single spiral groove renders the arrangement vulnerable to contaminating material blocking the groove and thereby preventing the action of the bushing in causing a flow along the groove.

Furthermore, a throat bushing with a spiral groove can only be uni-directional. If the rotation of the shaft is in one direction, then the device works as described. However, if the rotation of the shaft is in the other direction, then the fluid flow is not in the designed direction and contaminating material is moved in the direction towards the cavity seals.

In certain situations, for example double ended pumps, a throat bush is positioned towards either end of the longitudinal shaft. In the case of an uni-directional throat bush design, two bush designs are required with clockwise and counter-clockwise spiral grooves. This leads to increased customer inventory and increased likelihood of installation error.

In addition, longitudinally travelling fluid operating in a throat bush with a radially declining surface, tapered towards the cavity entrance, has to fight the effects of the centrifugal forces acting on the fluid from the shaft. In summary, said centrifugal forces give the fluid a radial direction, which opposes and impedes the longitudinally fluid movement. This means that flush rate of the supply fluid must be increased to overcome a undesirable effects inherent in a tapered construction of this nature.

Our co-pending application no. PCT/GB2007/001674 provides a seal cavity throat bushing which is an annular element adapted for a tight fit in the equipment housing at the entrance to the cavity opposite the end where the sealing means is situated. The element has a radially outer cylindrical surface for contacting a cavity wall of the housing and a radially inner cylindrical surface having a diameter greater than that of the shaft to define a gap therebetween. The element is provided with a first annular face surface at the cavity entrance, a second annular face surface at the cavity exit and a third annular face surface, positioned longitudinally between the first and second annular faces, substantially perpendicular to the shaft. The third annular face surface is provided with a least one vane which extends from a radially outer position to a radially inner position and which slopes from the third annular face inwardly towards the cavity entrance and the first annular face.

The above described throat bushings are typically made of a hard material such as a metal or metal alloy and they are machined items requiring substantial machine and operator time and involving considerable wastage of material.

### Statements of the Invention

The present invention provides a seal cavity throat bushing for use with rotating fluid equipment having a seal cavity which is defined by a rotary shaft having an axis, a shaft housing surrounding at least a portion of the shaft, and a sealing device engaging the shaft and said housing at one end of the cavity, said bushing comprising an annular element adapted for a tight fit in said housing at the entrance to said cavity opposite said one end, said element having a radially outer cylindrical surface for contacting a cavity wall of said housing, and a radially inner cylindrical surface having a diameter greater than that of said shaft to define a gap therebetween, said element being made by a process requiring no machining or other treatment.

Preferably, the process is a casting process such as a pressure die casting process or a lost wax process. The throat bushing as we mentioned may be made of any suitable material, for instance, brass or another metal suitable for use in a pressure die casting or other non-machining process.

Preferably, a throat bushing of the invention is made from a resilient or elatastomeric material such as rubber. An example of a suitable material is that sold under the trade mark Viton which may be injection moulded to produce the throat bushing in a single piece.

The use of a material such as Viton is advantageous in that contaminating particles impinging on the material will tend to be deflected therefrom without causing any damage to the bushing.

A particular material of use in the present invention is Viton of 90 Shore hardness. Throat bushing of the invention may be a plain ring or it may be profiled as described, for example, in our co-pending application no. PCT/GB2007/001674.

### DESCRIPTION OF THE DRAWING

The accompanying drawing is a longitudinal section of part of rotary equipment including a throat bushing in accordance with the present invention.

### DETAILED DESCRIPTION OF THE INVENTION

The present invention will now be described, by way of example only, and with reference to the accompanying drawing.

The rotary equipment shown in the accompanying drawing includes a shaft 1 which is free to circumferentially rotate and an equipment housing 3 which is circumferentially stationary.

Between equipment housing 3 and shaft 1 is a sealed cavity 5 which is further defined by seal means in the form of a series of packing rings 7 and a gland ring 9 and secured to the housing 3 by bolts 11.

Also occupying the seal cavity is a throat bushing 13 which comprises an annular element 15 adapted for a tight fit in the housing 3 and being located at an entrance to cavity 5 opposite the end occupied by the packing rings.

Annular element 15 of throat bushing 13 has a radially inner cylindrical surface 17 with a diameter greater than that of shaft 1, thereby defining a gap therebetween.

Throat bush 13 has a first annular face surface 20 which communicates with the pumped fluid, a second annular face surface 21 which communicates with the packing rings 7 and a third annular face surface 22, axially positioned between first 21 and second 21 annular faces, and substantially perpendicular to the shaft 1.

The throat bush is otherwise substantially as described in our co-pending application no. PCT/GB2007/001674.

The above described throat bushing is made of a rubber-like material which is Viton of 90 Shore hardness. It is made by a single non-machiningg process, in particular the lost wax casting process.

The material has a resiliency such that the particle impinging on it will not damage it in anyway. Furthermore the process used in its manufacture is a rapid process involving no machining and no wastage of material and no production of swarf which accompanies machining operations.

1-6. (canceled)

7. A seal cavity throat bushing for use with rotating fluid equipment having a seal cavity defined by a rotary shaft having an axis with a housing for the rotary shaft at least partially surrounding the rotary shaft, and a sealing device engaging the rotary shaft and the housing for the rotary shaft at one end of the seal cavity, said seal cavity throat bushing comprising:
an annular element for fitting in the housing for the rotary shaft at an entrance to the seal cavity opposite the one end, said annular element having a radially outer cylindrical surface for contacting a cavity wall of the housing of the rotary shaft and a radially inner cylindrical surface having a diameter greater than that of the rotary shaft for defining a gap therebetween.

8. The seal cavity throat bushing according to claim 7, wherein said seal cavity throat bushing is made of rubber.
